(19) United States
(12) Patent Application Publication
(10) Pub. No.: US 2023/0420970 A1
(43) Pub. Date: Dec. 28, 2023

(54) ELECTRIC POWER TOOL

(71) Applicant: BASSO INDUSTRY CORP., TAICHUNG (TW)

(72) Inventors: CHENG-EN TSAI, TAICHUNG (TW); CHUN-MIN SHIH, TAICHUNG (TW)

(73) Assignee: BASSO INDUSTRY CORP., TAICHUNG (TW)

(21) Appl. No.: 18/337,679

(22) Filed: Jun. 20, 2023

(30) Foreign Application Priority Data
Jun. 22, 2022 (TW) 111206622

(51) Int. Cl. H02J 7/00; B25F 5/00

(52) U.S. Cl. CPC H02J 7/00712; B25F 5/00; H02J 7/00711; H02J 7/0063; H02J 7/00045

(57) ABSTRACT

An electric power tool includes a battery for outputting electric energy, and an operating device electrically connected to the battery for receiving the electric energy and adapted to operate based on the electric energy. The operating device includes a power module that is configured to output an operating power based on the electric energy; a driving module that is configured to drive a motor to operate based on the operating power; and a control module that is configured to, based on a capacity of the battery, control the driving module to adjust a proportion of the operating power sent from the power module to the motor in a manner that the proportion of the operating power is positively correlated to the capacity of the battery, and to terminate operation of the motor when the electric energy is less than a minimum operating voltage that is determined for the battery.

### CROSS-REFERENCE TO RELATED APPLICATION

This application claims priority to Taiwanese Utility Model Patent Application No. 111206622, filed on Jun. 22, 2022.

### FIELD

The disclosure relates to an electric power tool, and more particularly to an electric power tool adapted for use with batteries with different capacities.

### BACKGROUND

Conventional electric power tools (e.g., an electric nail gun, a drill, etc.) may be adapted for use with various types of batteries. However, when a conventional electric power tool with a high power consumption is used with a battery that has a small capacity, the conventional electric power tool may trigger an overcurrent protection mechanism of the battery, interrupting operation of the conventional electric power tool. For example, abruptly stopping an electric nail gun during its operation might cause an impact component of the electric nail gun to be in an unsafe position. Similarly, abruptly stopping a drill in the middle of drilling may result in incomplete drilling or poor drilling quality.

### SUMMARY

Therefore, an object of the disclosure is to provide an electric power tool that can alleviate at least one of the drawbacks of the prior art.

According to the disclosure, an electric power tool includes a battery unit and an operating device. The battery unit includes a battery positive terminal and a battery negative terminal that are cooperatively configured to output electric energy. The operating device includes a device positive terminal, a device negative terminal, a power module, a motor, a driving module, and a control module. The device positive terminal and the device negative terminal are electrically connected to the battery positive terminal and the battery negative terminal, respectively, to receive the electric energy therefrom. The power module is electrically connected to the device positive terminal and the device negative terminal to receive the electric energy therefrom, and is configured to output an operating power based on the electric energy. The driving module is electrically connected to the power module and the motor, and is configured to drive the motor to operate based on the operating power. The control module is electrically connected to the power module and the driving module, and is configured to, based on a capacity of the battery unit, control the driving module to adjust a proportion of the operating power sent from the power module to the motor in a manner that the proportion of the operating power sent to the motor is positively correlated to the capacity of the battery unit, and determine a minimum operating voltage for the battery unit.

According to the disclosure, an electric power tool is adapted to operate based on electric energy provided by a battery unit. The battery unit includes a battery positive terminal and a battery negative terminal that are cooperatively configured to output the electric energy. The electric power tool includes a device positive terminal, a device negative terminal, a power module, a motor, a driving module, and a control module. The device positive terminal and the device negative terminal are configured to be electrically connected to the battery positive terminal and the battery negative terminal, respectively, to receive the electric energy therefrom. The power module is electrically connected to the device positive terminal and the device negative terminal to receive the electric energy therefrom, and is configured to output an operating power based on the electric energy. The driving module is electrically connected to the power module and the motor, and is configured to drive the motor to operate based on the operating power. The control module is electrically connected to the power module and the driving module, and is configured to, based on a capacity of the battery unit, control the driving module to adjust a proportion of the operating power sent from the power module to the motor in a manner that the proportion of the operating power sent to the motor is positively correlated to the capacity of the battery unit, and determine a minimum operating voltage for the battery unit.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an electric power tool according to an embodiment of the disclosure.

FIG. 2 is a circuit diagram illustrating some components of an electric power tool according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

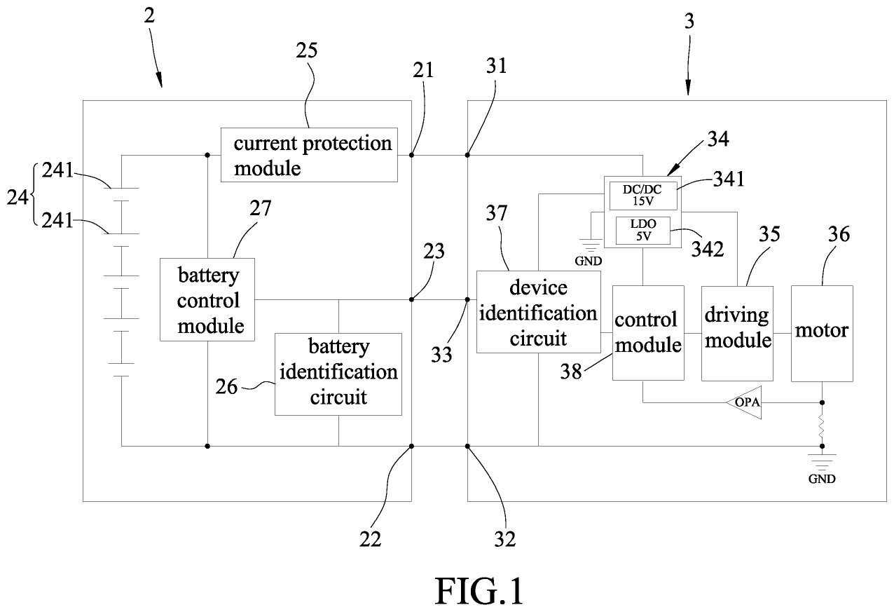

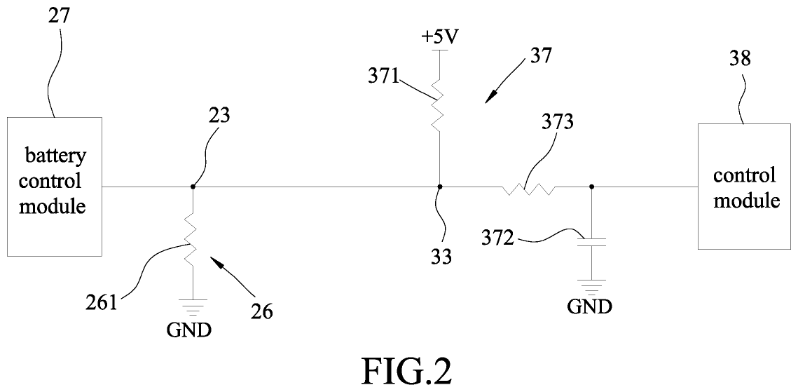

Referring to FIGS. 1 and 2, an electric power tool according to an embodiment of the disclosure includes a battery unit 2 and an operating device 3. It should be noted that the operating device 3 is adapted to operate based on electric energy provided by various types of battery units respectively having different capacities according to embodiments of this disclosure, but only one battery unit 2, which is removably connected to the operating device 3, is illustrated in the drawings and is explained in the following for the sake of brevity. The battery unit 2 includes a battery positive terminal 21, a battery negative terminal 22, a battery identification terminal 23, a battery module 24, a current protection module 25, a battery identification circuit 26, and a battery control module 27. It should be noted that although different types of battery units have different capacities, the battery units have the same block diagram and the same equivalent circuit.

The battery positive terminal 21 and the battery negative terminal 22 are cooperatively configured to output electric energy. The battery module 24 includes a set of batteries 241 for providing the electric energy. For example, the batteries 241 are electrically connected in series. The current protection module and the battery module 24 are connected in series between the battery positive terminal 21 and the battery negative terminal 22. The current protection module 25 is configured for providing a protection mechanism when a current is too large, and may be implemented using a fuse.

The battery identification circuit 26 may be implemented using a resistor 261 (hereinafter referred to as “identification resistor”), where the identification resistor 261 has one end electrically connected to the battery identification terminal 23 and the battery control module 27, and another end electrically connected to the battery negative terminal 22 (represented as ground terminal (GND) in FIG. 2).

The battery control module 27 may be implemented using a battery management system (BMS) to manage the batteries 241 according to a battery voltage of the set of batteries 241, a current of the set of batteries 241, a temperature of the set of batteries 241, etc., so as to avoid abnormal conditions such as over-discharging, over-charging, or over-heating of the batteries 241. Since the BMS is well-known to one having ordinary skill in the art, it will not be described in further detail for the sake of brevity.

The operating device 3 includes a device positive terminal 31, a device negative terminal 32, a device identification terminal 33, a power module 34, a driving module 35, a motor 36, a device identification circuit 37, and a control module 38.

When the battery unit 2 is connected to the operating device 3, the device positive terminal 31 and the device negative terminal 32 are electrically connected to the battery positive terminal 21 and the battery negative terminal 22, respectively, to receive the electric energy therefrom, and the device identification terminal 33 is electrically connected to the battery identification terminal 23.

The power module 34 is electrically connected to the device positive terminal 31 and the device negative terminal 32 to receive the electric energy therefrom, and is configured to output an operating power based on the electric energy. The power module 34 may include a direct-current to direct-current converter (DC-DC converter) 341 (e.g., 15V) and a low-dropout (LDO) regulator 342 (e.g., 5V) for providing the operating power with different voltages.

The driving module 35 is electrically connected to the power module 34, the motor 36, and the control module 38, and is configured to drive the motor 36 to operate based on the operating power and a pulse signal that is outputted by the control module 38 in the form of a pulse-width modulation (PWM) signal. The driving module 35 may be implemented using a metal-oxide-semiconductor field-effect transistor (MOSFET) switch. The motor 36 may be implemented using a brushless direct current motor (BLDC).

The device identification circuit 37 is electrically connected between the device identification terminal 33 and the control module 38, and may include a voltage-dividing resistor 371, a voltage stabilizing capacitor 372, and a buffer resistor 373. The voltage-dividing resistor 371 has one end electrically connected to the power module 34 for receiving the operating power (represented as +5V in FIG. 2), and another end electrically connected to the device identification terminal 33. The voltage stabilizing capacitor 372 is serially connected between the control module 38 and the device negative terminal 32 (represented as GND in FIG. 2). The buffer resistor 373 is serially connected between the device identification terminal 33 and the control module 38.

The control module 38 is electrically connected to the power module 34, the driving module 35, and the device identification circuit 37, and stores a plurality of data sets, for example, a first data set related to correspondence of different values of a divided voltage at the device identification terminal 33 respectively to different capacities of the battery units (i.e., different types of battery units), and a second data set related to correspondence of the different capacities of the battery units respectively to a plurality of operating power proportions and a plurality of minimum operating voltages. The control module 38 may be implemented as a circuit (e.g., a microcontroller) with functions of analog-to-digital conversion (A/D conversion), input/output detection (I/O detection), and PWM output, etc.

The control module 38 is configured to determine a capacity of the battery unit 2 based on a capacity signal received from the device identification terminal 33. For example, the control module 38 may receive the divided voltage that is generated by the voltage-dividing resistor 371 and the identification resistor 261 at the device identification terminal 33 as the capacity signal, and determine the capacity of the battery unit 2 by looking up the data sets based on the divided voltage thus received.

The control module 38 is further configured to, based on the capacity of the battery unit 2, control the driving module 35 to adjust a proportion of the operating power sent from the power module 34 to the motor 36 in a manner that the proportion of the operating power sent to the motor 36 is positively correlated to the capacity of the battery unit 2, and determine a minimum operating voltage for the battery unit 2.

The control module 38 may first determine an operating power proportion and the minimum operating voltage for the battery unit 2 by looking up the data sets based on the capacity of the battery unit 2 thus determined. Then, the control module 38 may output the pulse signal with a predetermined duty cycle to the driving module 35 based on the operating power proportion, thereby controlling the driving module 35 to adjust the proportion of the operating power sent from the power module 34 to the motor 36.

The control module 38 is further configured to control the driving module 35 to terminate operation of the motor 36 when the electric energy provided by the battery unit 2 is less than the minimum operating voltage thus determined.

An example is demonstrated as follows. Table 1 below shows correspondence of different resistance values of the identification resistor 261 respectively to different battery types of the battery units. Since different battery types of the battery units correspond to different resistance values of the identification resistor 261, and since a resistance value of the voltage-dividing resistor 371 (hereinafter referred to as “first resistance value”) and a voltage of the operating power are known, the control module 38 may determine a resistance value of the identification resistor 261 (hereinafter referred to as “second resistance value”) based on the divided voltage at the device identification terminal 33. Therefore, the second resistance value of the identification resistor 261 can be used to determine the capacity and/or the battery type of the battery unit 2 that the electric power tool is currently connected to.

TABLE 1

| | Identification |
|---|---|
| Battery Type | Resistor (ohm) |
| A | 5.1K |
| B | 16.2K |
| C | 12.4K |
| D | 22K |

Table 2 below shows an example of the data sets that are stored in the control module 38. The data sets include, for the different battery types of the battery units, correspondence of the different capacities respectively to the operating power proportions and the minimum operating voltages. The control module 38 may then determine the capacity, the operating power proportion, and the minimum operating voltage based on the battery type of the battery unit 2 thus determined.

TABLE 2

| Battery | Capacity | Operating Power | Minimum Operating |
|---|---|---|---|
| Type | (Ah) | Proportion (%) | Voltage (V) |
| A | 2.5 | 70 | 17.5 |
| B | 4.0 | 90 | 17.0 |
| C | 5.0 | 100 | 16.5 |
| D | 8.0 | 100 | 16.0 |

Specifically, the operating power proportion is positively correlated to the capacity of the battery unit 2 when the capacity of the battery unit 2 is less than or equal to a predetermined capacity (e.g., 5.0 Ah), and the operating power proportion is equal to 100% when the capacity of the battery unit 2 is greater than the predetermined capacity. The minimum operating voltage is negatively correlated to the capacity of the battery unit 2. A 100% operating power proportion means that the predetermined duty cycle of the pulse signal is 100%, and a 70% operating power proportion means that the predetermined duty cycle of the pulse signal is 70%.

When the battery voltage of the battery unit 2 (i.e., the battery voltage of the set of the batteries 241) decreases due to power consumption after the battery unit 2 has been used, the control module 38 is configured to compensate for the decrease in the battery voltage by, for example, gradually increasing the duty cycle of the pulse signal that is being outputted to the driving module 35 (there is a negative correlation manner between the battery voltage and the duty cycle of the pulse signal) to maintain a stable rotational speed for the motor 36.

In some embodiments, the control module 38 stores a third data set that is related to correspondence of different values of the divided voltage at the device identification terminal 33 to the operating power proportions and the minimum operating voltages, and the control module 38 may directly determine the operating power proportion and the minimum operating voltage for the battery unit 2 based on the divided voltage that is received from the device identification terminal 33, without the need to determine the capacity of the battery unit 2.

In summary, the operating device 3 is configured to control the driving module 35 to adjust the proportion of the operating power sent from the power module 34 to the motor 36 based on the capacity of the battery unit 2 so that the two have a positive correlation, and determine the minimum operating voltage for the battery unit 2. The operating device 3 is further configured to terminate operation of the motor 36 when the electric energy provided by the battery unit 2 (i.e., the battery voltage of the set of batteries 241) is less than the minimum operating voltage that corresponds to the capacity of the battery unit 2. If the electric power tool is coupled to the battery unit 2 that has a small capacity, the operating device 3 may control the driving module 35 to decrease the proportion of the operating power sent from the power module 34 to the motor 36, so as to decrease the load current of the battery unit 2. As such, one may avoid triggering the protection mechanism of the battery unit 2 that has a small capacity, and avoid over-heating of the battery unit 2 due to excess current, which may result in decrease in a service life of the battery unit 2. In addition, having the data sets stored in the control module 38 allows the control module 38 to quickly look up the operating power proportion and the minimum operating voltage that correspond to the capacity of the battery unit 2.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric power tool comprising:
a battery unit including a battery positive terminal and a battery negative terminal that are cooperatively configured to output electric energy; and
an operating device including
a device positive terminal and a device negative terminal that are electrically connected to said battery positive terminal and said battery negative terminal, respectively, for receiving the electric energy therefrom,
a power module electrically connected to said device positive terminal and said device negative terminal for receiving the electric energy therefrom, and configured to output an operating power based on the electric energy,
a motor,
a driving module electrically connected to said power module and said motor, and configured to drive said motor to operate based on the operating power, and
a control module electrically connected to said power module and said driving module, and configured to, based on a capacity of said battery unit, control said driving module to adjust a proportion of the operating power sent from said power module to said motor in a manner that the proportion of the operating power sent to the motor is positively correlated to the capacity of the battery unit, and determine a minimum operating voltage for said battery unit,
wherein said control module is further configured to control said driving module to terminate operation of said motor when the electric energy provided by said battery unit is less than the minimum operating voltage that corresponds to the capacity of said battery unit.

2. The electric power tool as claimed in claim 1, wherein said control module is configured to control said driving module to adjust the proportion of the operating power sent from said power module to said motor by outputting a pulse signal with a predetermined duty cycle to said driving module, where the duty cycle of the pulse signal corresponds to the capacity of said battery unit.

3. The electric power tool as claimed in claim 1, wherein the minimum operating voltage is negatively correlated to the capacity of said battery unit.

4. The electric power tool as claimed in claim 1, wherein said battery unit further includes a battery identification terminal, said operating device further includes a device identification terminal that is electrically connected to said battery identification terminal, and said control module is electrically connected to said device identification terminal and is configured to determine the capacity of said battery unit based on a capacity signal received from said device identification terminal.

5. The electric power tool as claimed in claim 4, wherein:
said battery unit further includes an identification resistor that is electrically connected between said battery identification terminal and said battery negative terminal and that has a resistance value corresponding to the capacity of said battery unit;
said operating device further includes a voltage-dividing resistor that has one end electrically connected to said power module for receiving the operating power therefrom, and another end electrically connected to said device identification terminal; and
said control module is configured to receive a divided voltage at said device identification terminal as the capacity signal and to determine the capacity of said battery unit based on the divided voltage.

6. The electric power tool as claimed in claim 5, wherein said control module stores a first data set related to correspondence of a value of the divided voltage at said device identification terminal to the capacity of said battery unit, and a second data set related to correspondence of the capacity of said battery unit to an operating power proportion and the minimum operating voltage.

7. The electric power tool as claimed in claim 5, wherein said control module stores a first data set related to correspondence of a value of the divided voltage at said device identification terminal to an operating power proportion and the minimum operating voltage.

8. An electric power tool adapted to operate based on electric energy provided by a battery unit, the battery unit including a battery positive terminal and a battery negative terminal that are cooperatively configured to output the electric energy, said electric power tool comprising:
a device positive terminal and a device negative terminal that are configured to be electrically connected to the battery positive terminal and the battery negative terminal, respectively, for receiving the electric energy therefrom;
a power module electrically connected to said device positive terminal and said device negative terminal for receiving the electric energy therefrom, and configured to output an operating power based on the electric energy;
a motor;
a driving module electrically connected to said power module and said motor, and configured to drive said motor to operate based on the operating power; and
a control module electrically connected to said power module and said driving module, and configured to, based on a capacity of the battery unit, control said driving module to adjust a proportion of the operating power sent from said power module to said motor in a manner that the proportion of the operating power sent to the motor is positively correlated to the capacity of the battery unit, and determine a minimum operating voltage for the battery unit,
wherein said control module is further configured to control said driving module to terminate operation of said motor when the electric energy provided by said battery unit is less than the minimum operating voltage that corresponds to the capacity of said battery unit.

9. The electric power tool as claimed in claim 8, wherein said control module is configured to control said driving module to adjust the proportion of the operating power sent from said power module to said motor by outputting a pulse signal to said driving module, where a duty cycle of the pulse signal corresponds to the capacity of the battery unit.

10. The electric power tool as claimed in claim 8, wherein the minimum operating voltage is negatively correlated to the capacity of the battery unit.

11. The electric power tool as claimed in claim 8, the battery unit further including a battery identification terminal,
wherein said operating device further includes a device identification terminal that is configured to be electrically connected to the battery identification terminal, and said control module is electrically connected to said device identification terminal and is configured to determine the capacity of the battery unit based on a capacity signal received from said device identification terminal.

12. The electric power tool as claimed in claim 11, the battery unit further including an identification resistor that is electrically connected between the battery identification terminal and the battery negative terminal and that has a resistance value corresponding to the capacity of the battery unit,
wherein said operating device further includes a voltage-dividing resistor that has one end electrically connected to said power module for receiving the operating power therefrom, and another end electrically connected to said device identification terminal, and
wherein said control module is configured to receive a divided voltage at said device identification terminal as the capacity signal and to determine the capacity of the battery unit based on the divided voltage.

13. The electric power tool as claimed in claim 12, adapted to operate based on electric energy provided by various types of battery units respectively having different capacities,
wherein said control module stores a first data set related to correspondence of different values of the divided voltage at said device identification terminal respectively to the different capacities of the battery units, and a second data set related to correspondence of the different capacities of the battery units respectively to a plurality of operating power proportions and respectively to a plurality of minimum operating voltages.

14. The electric power tool as claimed in claim 12, wherein said control module stores a first data set related to correspondence of different values of the divided voltage at said device identification terminal respectively to a plurality of operating power proportions and respectively to a plurality of minimum operating voltages.
